(19) United States
(12) Patent Application Publication
(10) Pub. No.: US 2013/0243497 A1
(43) Pub. Date: Sep. 19, 2013

(54) DEVELOPER SUPPLY DEVICE AND IMAGE FORMING APPARATUS HAVING THE SAME

(71) Applicants: Suzue TAKU, Hikone-shi (JP); Kazuna TAGUCHI, Nagoya (JP)

(72) Inventors: Suzue TAKU, Hikone-shi (JP); Kazuna TAGUCHI, Nagoya (JP)

(73) Assignee: BROTHER KOGYO KABUSHIKI KAISHA, Nagoya (JP)

(21) Appl. No.: 13/785,662

(22) Filed: Mar. 5, 2013

(30) Foreign Application Priority Data
Mar. 16, 2012 (JP) 2012-060584

(51) Int. Cl. G03G 15/08

(52) U.S. Cl. CPC G03G 15/0806
USPC 399/281; 399/284

(57) ABSTRACT

A developer supply device is provided that includes an electric-field transfer board having transfer electrodes arranged along a developer transfer path so as to transfer development agent from a developer storage section along the developer transfer path when a multi-phase alternating-current voltage is applied to the transfer electrodes, a brush roller disposed to face an intended device in a developer supplying position and face the electric-field transfer board in a developer carrying position so as to receive the development agent from the electric-field transfer board and supply the received development agent to the intended device, and a regulating member disposed to contact the brush roller in a position between the developer carrying position and the developer supplying position so as to regulate an amount of the development agent on the brush roller.

### CROSS-REFERENCE TO RELATED APPLICATION

This application claims priority under 35 U.S.C. §119 from Japanese Patent Applications No. 2012-060584 filed on Mar. 16, 2012. The entire subject matter of the application is incorporated herein by reference.

### BACKGROUND

1. Technical Field

The following description relates to one or more techniques for supplying charged development agent to an intended device.

2. Related Art

As an example of developer supply devices, a fur brush developing type device has been known. The known developer supply device is configured to supply development agent to an intended device (specifically, to a photoconductive drum), using a brush roller with a lot of fibers radially extending from an outer circumferential surface thereof. In the known developer supply device, the development agent is supplied to the brush roller, for instance, which is disposed to face a developer storage section or is disposed to contact a supply roller.

### SUMMARY

Aspects of the present invention are advantageous to provide one or more improved techniques, for a developer supply device, which make it possible to charge, as adequately as practicable, development agent to be supplied from a brush roller to an intended device.

According to aspects of the present invention, a developer supply device is provided that is configured to supply charged development agent to an intended device, the developer supply device including an electric-field transfer board including a plurality of transfer electrodes arranged along a predetermined developer transfer path, the electric-field transfer board configured to transfer the development agent along the predetermined developer transfer path from a developer storage section that accommodates the development agent, when a multi-phase alternating-current voltage is applied to the plurality of transfer electrodes, a brush roller disposed to face the intended device in a predetermined developer supplying position and face the electric-field transfer board in a predetermined developer carrying position, the brush roller configured to receive the development agent from the electric-field transfer board in the predetermined developer carrying position and supply the received development agent to the intended device in the predetermined developer supplying position, and a regulating member configured to contact the brush roller in a position between the predetermined developer carrying position and the predetermined developer supplying position so as to regulate an amount of the development agent carried on the brush roller.

According to aspects of the present invention, further provided is an image forming apparatus that includes an image carrying body configured to carry an electrostatic latent image formed thereon, and a developer supply device configured to supply charged development agent to the image carrying body to develop the electrostatic latent image carried on the image carrying body, the developer supply device including a developer storage section configured to accommodate the development agent, an electric-field transfer board including a plurality of transfer electrodes arranged along a predetermined developer transfer path, a transfer bias supply circuit configured to supply a multi-phase alternating-current voltage to the plurality of transfer electrodes on the electric-field transfer board to transfer the development agent along the predetermined developer transfer path from the developer storage section toward a predetermined developer carrying position, a brush roller disposed to face the image carrying body in a predetermined developer supplying position and face the electric-field transfer board in the predetermined developer carrying position, the brush roller configured to receive the development agent from the electric-field transfer board in the predetermined developer carrying position and supply the received development agent to the image carrying body in the predetermined developer supplying position, and a regulating member configured to contact the brush roller in a position between the predetermined developer carrying position and the predetermined developer supplying position so as to regulate an amount of the development agent carried on the brush roller.

### BRIEF DESCRIPTION OF THE ACCOMPANYING DRAWINGS

FIG. 1 is a cross-sectional side view schematically showing a configuration of a laser printer in an embodiment according to one or more aspects of the present invention.

FIG. 2 is an enlarged cross-sectional side view of a toner supply device shown in FIG. 1 in the embodiment according to one or more aspects of the present invention.

FIG. 3 is an enlarged cross-sectional side view of an electric-field transfer board shown in FIG. 2 in the embodiment according to one or more aspects of the present invention.

FIG. 4 exemplifies waveforms of output voltages generated by power supply circuits for the electric-field transfer board in the embodiment according to one or more aspects of the present invention.

FIG. 5 is a graph showing a difference in electric charge distribution of toner on a development roller between when a regulating member is provided and when the regulating member is not provided in the embodiment according to one or more aspects of the present invention.

FIG. 6 is a graph showing a difference in negatively charged particle rate (i.e., a ratio of the number of negatively charged toner particles to the number of all charged toner particles) of the toner on the development roller between when the regulating member is provided and when the regulating member is not provided in the embodiment according to one or more aspects of the present invention.

FIG. 7 is a graph showing a difference in degree of occurrence of white fog on the development roller between when the regulating member is provided and when the regulating member is not provided in the embodiment according to one or more aspects of the present invention.

FIG. 8 is a cross-sectional side view schematically showing a configuration of a toner supply device for the laser printer in a modification according to one or more aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect.

Hereinafter, an embodiment according to aspects of the present invention will be described with reference to the accompany drawings.

### Configuration of Laser Printer

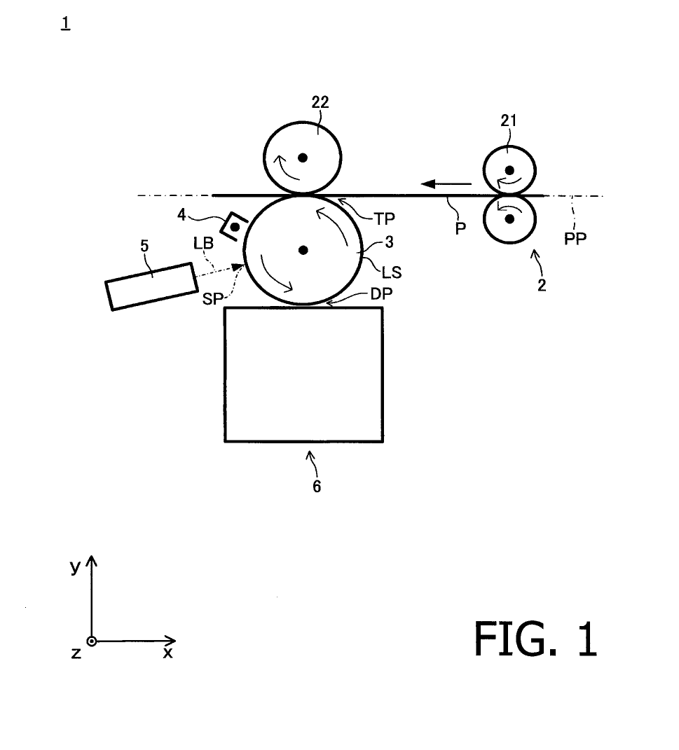

As illustrated in FIG. 1, a laser printer 1 includes a sheet feeding mechanism 2, a photoconductive drum 3, a charger 4, a scanning unit 5, and a toner supply device 6. The laser printer 1 further includes therein a feed tray (not shown) configured to accommodate sheets P stacked thereon. The sheet feeding mechanism 2 is configured to feed a sheet P along a predetermined sheet feeding path PP.

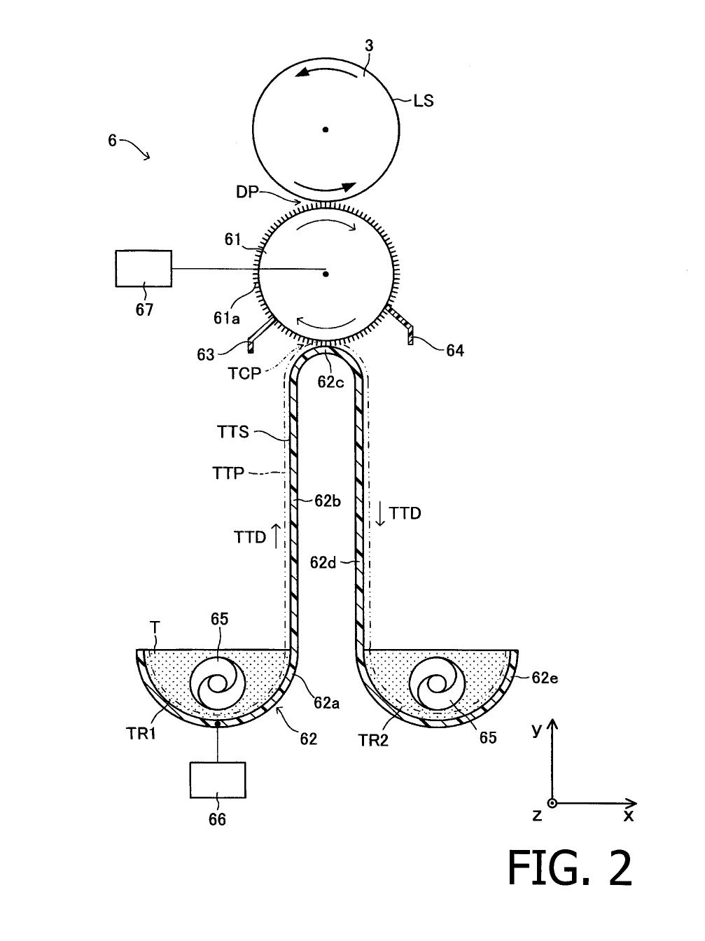

On a circumferential surface of the photoconductive drum 3, an electrostatic latent image carrying surface LS is formed as a cylindrical surface parallel to a main scanning direction (i.e., a z-axis direction in FIG. 1, which may be referred to as a “sheet width direction” as well). The electrostatic latent image carrying surface LS is configured to carry toner T (see FIG. 2) in positions corresponding to an electrostatic latent image, which is formed on the electrostatic latent image carrying surface LS in accordance with an electric potential distribution. The photoconductive drum 3 is driven to rotate in a counterclockwise direction indicated by arrows in FIG. 1 around an axis parallel to the main scanning direction. Thus, the photoconductive drum 3 is configured to move the electrostatic latent image carrying surface LS along an auxiliary scanning direction (typically, an x-axis direction in FIG. 1) perpendicular to the main scanning direction.

The charger 4 is disposed to face the electrostatic latent image carrying surface LS. The charger 4, which is of a corotron type or a scorotron type, is configured to positively charge the electrostatic latent image carrying surface LS (specifically, to charge the electrostatic latent image carrying surface LS to an electric potential of +700 V).

The scanning unit 5 is configured to generate a laser beam LB modulated based on image data. Specifically, the scanning unit 5 is configured to generate the laser beam LB within a predetermined wavelength range, which laser beam LB is emitted under ON/OFF control depending on whether there is a pixel (an image element) in a target location on the image data. In addition, the scanning unit 5 is configured to converge the laser beam LB in a scanned position SP on the electrostatic latent image carrying surface LS and move (scan) the convergence point of the laser beam LB along the main scanning direction at a constant speed. Here, the scanned position SP is set to a position downstream relative to the charger 4 and upstream relative to the toner supply device 6 in a moving direction of the electrostatic latent image carrying surface LS, which moves along with rotation of the photoconductive drum 3. In the embodiment, the scanning unit 5 is set to emit the laser beam LB onto the electrostatic latent image carrying surface LS charged to an electric potential of +700 V, so as to form an electrostatic latent image with an electric potential distribution of +150 V (exposed portions) and +700 V (unexposed portions).

The toner supply device 6 is disposed under the photoconductive body 3 so as to face the electrostatic latent image carrying surface LS. The toner supply device 6 is configured to supply the positively charged toner T (see FIG. 2) onto (the electrostatic latent image carrying surface LS of) the photoconductive drum 3 in a development position DP (where the toner supply device 6 is opposed in closest proximity to the electrostatic latent image carrying surface LS). It is noted that, in the embodiment, the toner T is positively-chargeable nonmagnetic-one-component dry-type black powder development agent. A detailed explanation will be provided later about a configuration of the toner supply device 6.

Subsequently, a detailed explanation will be provided about a specific configuration of each element included in the laser printer 1.

The sheet feeding mechanism 2 includes two registration rollers 21, and a transfer roller 22. The registration rollers 21 are configured to feed a sheet P toward between the photoconductive drum 3 and the transfer roller 22 at a predetermined moment (in accordance with predetermined timing). The transfer roller 22 is disposed to face the electrostatic latent image carrying surface LS across the sheet feeding path PP in a transfer position TP. Additionally, the transfer roller 22 is driven to rotate in a clockwise direction indicated by an arrow in FIG. 1. The transfer roller 22 is electrically connected with a transfer bias supply circuit (not shown), such that a predetermined transfer bias is applied between the transfer roller 22 and the photoconductive drum 3 so as to transfer, onto the sheet P, the toner T (see FIG. 2) adhering onto the electrostatic latent image carrying surface LS.

<<Toner Supply Device>>

FIG. 2 is a cross-sectional side view (a cross-sectional view taken along a plane with the main scanning direction as a normal line) showing the toner supply device 6 in an enlarged manner. As shown in FIG. 2, the toner supply device 6 includes a development roller 61, an electric-field transfer board 62, a regulating member 63, a retrieving member 64, augers 65, a transfer bias supply circuit 66, and a development bias supply circuit 67.

The development roller 61 is a brush roller having a lot of fibers radially extending from a cylindrical circumferential surface thereof. Specifically, in the embodiment, the development roller 61 includes a roller made of metal such as aluminum and nylon fibers (thickness: 3 denier, density: 120,000 pieces/inch², length: 5 mm, resistance: 10⁵-10⁸ Ω·cm) radially extending from a circumferential surface of the roller.

The development roller 61 is disposed to face the photoconductive drum 3 in the development position DP. Further, the development roller 61 is disposed to face the electric-field transfer board 62 in a toner carrying position TCP. Specifically, the development roller 61 is disposed in a position where an outer circumferential brush layer 61a thereof softly touches the photoconductive drum 3 and the electric-field transfer board 62 so as to slightly bend the aforementioned fibers.

The development roller 61 is driven to rotate in a clockwise direction indicated by arrows in FIG. 2 (which is a direction opposite to the rotational direction of the photoconductive drum 3). Thereby, the outer circumferential brush layer 61a is moved in the same direction as the moving direction of the electrostatic latent image carrying surface LS in the development position DP. Then, the development roller 61 receives the toner T from the electric-field transfer board 62, and supplies the received toner T to the photoconductive drum 3.

The electric-field transfer board 62 is configured to transfer the toner T along a toner transfer path TTP (i.e., a transfer path for the toner T that is formed along a toner transfer surface TTS as a surface of the electric-field transfer board 62) by a traveling-wave electric field, which is generated when the electric-field transfer board 62 is supplied with transfer biases each of which contains a direct-current (DC) voltage component and a corresponding one of multi-phase alternating-current (AC) voltage components. An internal configuration of the electric-field transfer board 62 will later be described in detail. Furthermore, the electric-field transfer board 62 is configured such that a toner transfer direction TTD (in which the toner is transferred on the toner transfer surface TTS) is opposite to the moving direction of the brush layer 61a of the development roller 61 in the toner carrying position TCP.

In the embodiment, the electric-field transfer board 62 is configured to transfer the toner T stored in a toner storage room TR1 toward the toner carrying position TCP, supply the toner T to the development roller 61 in the toner carrying position TCP, and transfer the toner T, which has passed through the toner carrying position TCP, to a toner storage room TR2 disposed adjacent to the toner storage room TR1. Namely, the electric-field transfer board 62 is formed to protrude toward the development roller 61 around the toner carrying position TCP. Specifically, the electric-field transfer board 62 includes an upstream curving section 62a, an upstream flat section 62b, an intermediate curving section 62c, a downstream flat section 62d, and a downstream curving section 62e.

The upstream curving section 62a, which faces the toner storage room TR1, is formed substantially in a semi-cylindrical shape having an upward-open cross-sectional side view. The upstream flat section 62b is formed substantially in a flat shape to connect the upstream curving section 62a with the intermediate curving section 62c. The upstream flat section 62b is configured to transfer the toner T upward in a vertical direction between the toner storage room TR1 to the toner carrying position TCP. The intermediate curving section 62c is disposed to face the development roller 61 in the toner carrying position TCP. The intermediate curving section 62c is formed substantially in a semi-cylindrical shape having a downward-open cross-sectional side view. The downstream flat section 62d is formed substantially in a flat shape to connect the intermediate curving section 62c with the downstream curving section 62e. The downstream flat section 62d is configured to transfer the toner T downward in the vertical direction between the toner carrying position TCP to the toner storage room TR2. The downstream curving section 62e, which faces the toner storage room TR2, is formed substantially in a semi-cylindrical shape having an upward-open cross-sectional side view.

In order to regulate an amount of the toner T carried by the outer circumferential brush layer 61a of the development roller 61, the regulating member 63 is configured to contact the development roller 61 in a position downstream relative to the toner carrying position TCP and upstream relative to the development position DP in the moving direction of the brush layer 61a, which moves in response to rotation of the development roller 61. In the embodiment, the regulating member 63 is a plate-shaped member referred to as a “regulating blade.” The regulating member 63 is disposed upstream relative to the toner carrying position TCP in the toner transfer direction TTD (i.e., above the toner storage room TR1).

In order to retrieve the toner T that remains on the development roller 61 after having passed through the development position DP, the retrieving member 64 is configured to contact the development roller 61 in a position downstream relative to the development position DP and upstream relative to the toner carrying position TCP in the moving direction of the brush layer 61a, which moves in response to rotation of the development roller 61. In the embodiment, the retrieving member 64 is a plate-shaped member referred to as a “flicker.” The retrieving member 64 is disposed downstream relative to the toner carrying position TCP in the toner transfer direction TTD (i.e., above the toner storage room TR2).

The toner supply device 6 contains the augers 65 at a bottom side thereof. The augers 65 are configured to, when driven to rotate, agitate and circulate the toner T in the toner storage rooms TR1 and TR2.

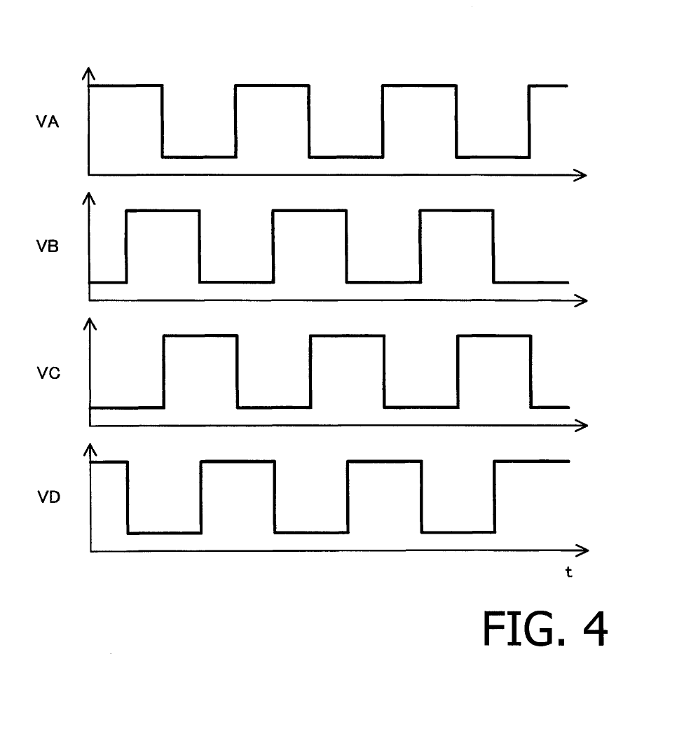

The electric-field transfer board 62 is electrically connected with the transfer bias supply circuit 66. The transfer bias supply circuit 66 is configured to output transfer biases (see FIG. 4) for transferring the toner T from the toner storage room TR1 to the toner storage room TR2 in the toner transfer direction TTD along the toner transfer path TTP. Specifically, in the embodiment, the transfer bias supply circuit 66 is configured to output transfer biases (+300 V to +900V) each of which contains a direct-current (DC) voltage component (+600 V) and a corresponding one of four-phase alternating-current (AC) voltage components (amplitude: 300 V, and frequency: 300 Hz).

The development roller 61 is electrically connected with the development bias supply circuit 67. The development bias supply circuit 67 is configured to output a voltage required for applying a development bias between the development roller 61 and the photoconductive drum 3. Specifically, in the embodiment, the development bias supply circuit 67 is configured to output a DC voltage of +300 V.

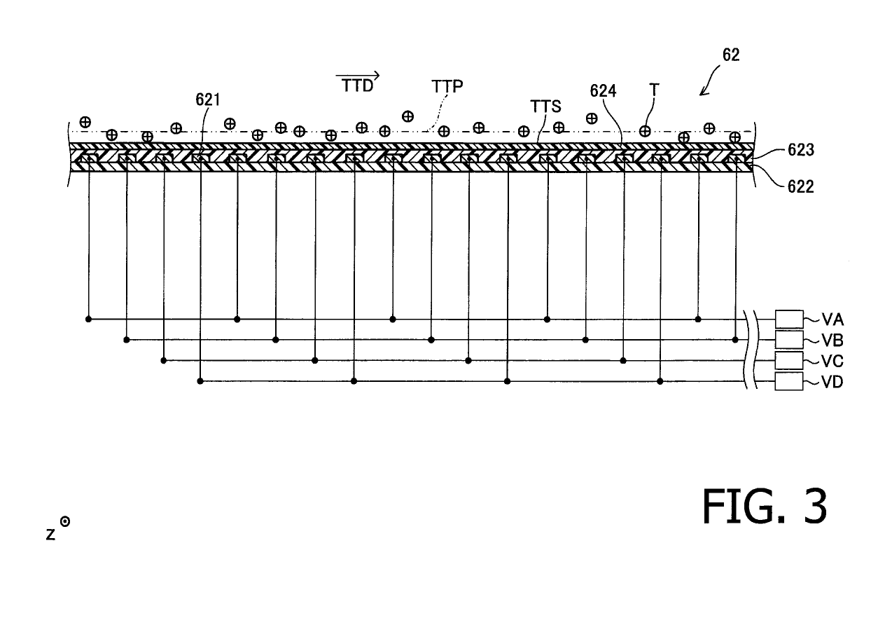

FIG. 3 is an enlarged cross-sectional side view showing the electric-field transfer board 62 shown in FIG. 2. As shown in FIG. 3, the electric-field transfer board 62 is a thin plate member having the same configuration as a flexible printed-circuit board. Specifically, the electric-field transfer board 62 includes a plurality of transfer electrodes 621, a transfer electrode supporting film 622, a transfer electrode coating layer 623, and a transfer electrode overcoating layer 624.

The transfer electrodes 621 are linear wiring patterns having a longitudinal direction parallel to the main scanning direction. The transfer electrodes 621 are formed, e.g., with copper thin films. The plurality of transfer electrodes 621 are arranged along the toner transfer path TTP in parallel with each other. Every fourth one of the transfer electrodes 621, arranged along the toner transfer path TTP, is connected with a specific one of four power supply circuits VA, VB, VC, and VD. In other words, the transfer electrodes 621 are arranged along the toner transfer path TTP in the following order: a transfer electrode 621 connected with the power supply circuit VA, a transfer electrode 621 connected with the power supply circuit VB, a transfer electrode 621 connected with the power supply circuit VC, a transfer electrode 621 connected with the power supply circuit VD, a transfer electrode 621 connected with the power supply circuit VA, a transfer electrode 621 connected with the power supply circuit VB, a transfer electrode 621 connected with the power supply circuit VC, a transfer electrode 621 connected with the power supply circuit VD, . . . . In the embodiment, as shown in FIG. 4, the power supply circuits VA, VB, VC, and VD are configured to generate respective AC driving voltages having substantially the same waveform, with a phase difference of 90 degrees between any adjacent two of the power supply circuits VA, VB, VC, and VD in the aforementioned order. In other words, the power supply circuits VA, VB, VC, and VD are configured to output the respective AC driving voltages each of which is delayed by a phase of 90 degrees behind the voltage output from a precedent adjacent one of the power supply circuits VA, VB, VC, and VD in the aforementioned order.

The transfer electrodes 621 are formed on a surface of the transfer electrode supporting film 622. The transfer electrode supporting film 622 is a flexible film made of polyimide resin. The transfer electrode coating layer 623 is provided to coat the transfer electrodes 621 and the surface of the transfer electrode supporting film 622 on which the transfer electrodes 621 are formed. In the embodiment, the transfer electrode coating layer 623 is made of polyimide resin. On the transfer electrode coating layer 623, the transfer electrode overcoating layer 624 is provided. The surface (the toner transfer surface TTS) of the transfer electrode overcoating layer 624 is formed to be a smooth surface with a very low level of irregularity, so as to smoothly convey the toner T thereon.

### Operations and Advantageous Effects

Subsequently, an explanation will be provided about a general overview of operations and advantageous effects of the toner supply device 6 configured as above in the embodiment.

In the embodiment, the positively charged toner T is transferred by the electric-field transfer board 62, from the toner storage room TR1 to the toner carrying position TCP in the toner transfer direction TTD along the toner transfer path TTP. Then, the toner T is transferred to and carried by the brush layer 61a of the development roller 61 in the toner carrying position TCP.

At this time, in the toner carrying position TCP, the toner T is transferred onto and carried on the development roller 61 (transferring of the toner T from the electric-field transfer board 62 to the development roller 61) in a state where the toner transfer surface TTS contacts the development roller 61 that is a brush roller). Thereby, most of the toner T transferred to the toner carrying position TCP is carried on the development roller 61, so as to achieve a favorable toner carrying state where the toner T is evenly carried on the development roller 61.

The brush layer 61a, which has carried the toner T in the toner carrying position TCP, reaches a position to contact the regulating member 63 along with rotation of the development roller 61. In the position, the brush roller 61a moves toward the development position DP while contacting the regulating member 63. Thereby, the amount of the toner T carried by the brush layer 61a is regulated in a favorable manner. After the amount of the toner T carried by the brush layer 61a is regulated by the regulating member 63, the brush layer 61a reaches the development position DP, where the toner T is supplied to the photoconductive drum 3 (i.e., the toner T is supplied for development of the electrostatic latent image formed on the electrostatic latent image carrying surface LS).

The toner T, which remains on the development roller 61 after having passed through the development position DP, is removed by the retrieving member 64, drops into the toner storage room TR2, and is retrieved there. Thereby, a development record (a trace of the toner T supplied to the photoconductive drum 3) formed in the development position DP is cleared in a favorable manner from the brush layer 61a of the development roller 61 on which the toner T remains after having passed through the development position DP. The toner T retrieved by the toner storage room TR2 is agitated by the auger 65 together with toner T previously stored in the toner storage room TR2, and is again conveyed to the toner storage room TR1.

Thus, in the embodiment, the adequately charged toner T, which is allowed to be transferred in a favorable manner by the traveling-wave electric field, is transferred to the toner carrying position TCP by the electric-field transfer board 62 and is carried on the development roller 61 in the toner carrying position TCP. Then, after the amount of the toner T carried on the development roller 61 is regulated by the regulating member 63 in a favorable manner, the toner T is supplied to the electrostatic latent image carrying surface LS.

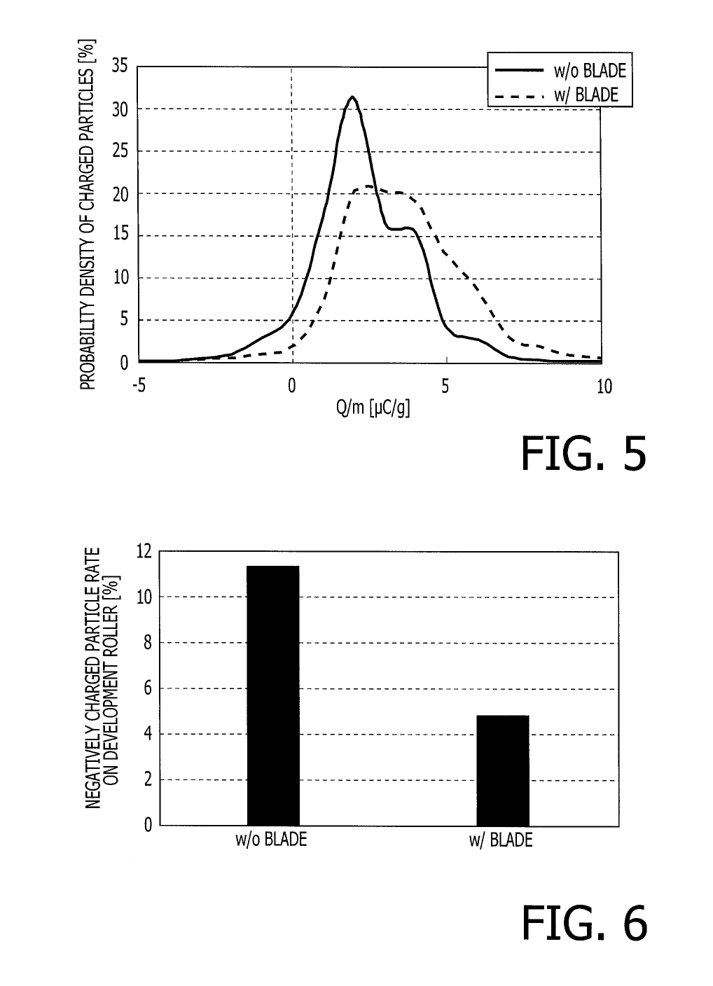

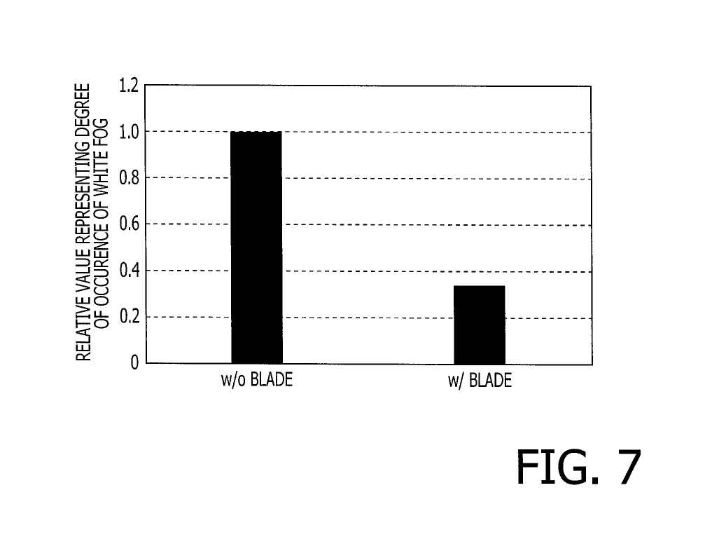

FIG. 5 shows a difference in electric charge distribution of the toner T on the development roller 61 between when the regulating member 63 shown in FIG. 2 is provided and when the regulating member 63 is not provided. FIG. 6 shows a difference in negatively charged particle rate (i.e., a ratio of the number of negatively charged toner particles to the number of all charged toner particles) of the toner T on the development roller 61 between when the regulating member 63 shown in FIG. 2 is provided and when the regulating member 63 is not provided. FIG. 7 shows a difference in degree of occurrence of white fog on the development roller 61 between when the regulating member 63 shown in FIG. 2 is provided and when the regulating member 63 is not provided.

In FIGS. 5 to 7, “w/blade” represents a result when the regulating member 63 is provided, while “w/o blade” represents a result when the regulating member 63 is not provided. Further, in FIG. 5, the horizontal axis represents an electric charge amount per unit mass Q/m [unit: μC/g]. Moreover, in FIG. 7, the vertical axis represents a relative value of a measured reflection density of a solid white portion on a regular sheet onto which a test pattern toner image formed on the photoconductive drum 3 is transferred in the case of “w/blade,”with respect to a reference value “1” which corresponds to a similarly measured reflection density in the case of “w/o blade.”

As is clear from the experimental results shown in FIGS. 5 to 7, according to the embodiment, when the amount of the toner T carried by the brush layer 61a is regulated by the regulating member 63, the negatively charged particle rate of the toner T carried by the brush layer 61a is reduced (see FIG. 6), the electric charge distribution shifts positively in the electric charge amount per unit mass Q/m (see FIG. 5), and the degree of occurrence of white fog on the photoconductive drum 3 is decreased (see FIG. 7).

Thus, according to the embodiment, it is possible to achieve a more adequately charged state of the toner T carried by the brush layer 61a of the development roller 61 that reaches the development position DP after having passed through the toner carrying position TCP than the charged state achieved in the known developer supply device. Hence, according to the embodiment, it is possible to as adequately as practicable charge the toner T to be supplied to the photoconductive drum 3 (the electrostatic latent image carrying surface LS) by the development roller 61 that is a brush roller.

Further, in the embodiment, the toner T is supplied onto the development roller 61 in a direction against the moving direction of the outer circumferential surface of the development roller 61 in the toner carrying position TCP. Further, the toner T, which remains on the development roller 61 after having passed through the development position DP, is retrieved by the retrieving member 64 that contacts the development roller 61 in the position downstream relative to the toner carrying position TCP in the toner transfer direction TTD. Thus, according to the toner supply device 6 configured as above in the embodiment, it is possible to make the development roller 61 carry the toner T and retrieve the toner T from the development roller 61 in a favorable manner.

Hereinabove, the embodiment according to aspects of the present invention has been described. The present invention can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present invention. However, it should be recognized that the present invention can be practiced without reapportioning to the details specifically set forth. In other instances, well known processing structures have not been described in detail, in order not to unnecessarily obscure the present invention.

Only an exemplary embodiment of the present invention and but a few examples of their versatility are shown and described in the present disclosure. It is to be understood that the present invention is capable of use in various other combinations and environments and is capable of changes or modifications within the scope of the inventive concept as expressed herein. For example, the following modifications are possible. It is noted that, in the following modifications, the same configurations as exemplified in the aforementioned embodiment will be provided with the same reference characters, and explanations about them will be omitted.

### Modifications

Aspects of the present invention may be applied to electrophotographic image forming apparatuses such as color laser printers, and monochrome and color copy machines, as well as the single-color laser printer as exemplified in the aforementioned embodiment. Further, the photoconductive body is not limited to the drum-shaped one as exemplified in the aforementioned embodiment. For instance, the photoconductive body may be formed in a shape of a plate or an endless belt.

Additionally, light sources (e.g., LEDs, electroluminescence devices, and fluorescent substances) other than a laser scanner (for the scanning unit 5) may be employed as light sources for exposing the photoconductive drum 3. In such cases, the “main scanning direction” may be parallel to a direction along which light emitting elements such as LEDs are aligned. Furthermore, aspects of the present invention may be applied to image forming apparatuses employing methods (such as a toner-jet method, an ion flow method, and a multi-stylus electrode method without using any photoconductive body) other than the aforementioned electrophotographic method.

The photoconductive drum 3 may be spaced apart from the development roller 61. Further, the development roller 61 may be spaced apart from the toner transfer surface TTS. Further, the configuration (e.g., the material, thickness, density, and length of the fibers) of the development roller 61 is not limited to that exemplified in the aforementioned embodiment.

The voltages generated by the power supply circuits VA, VB, VC, and VD may have an arbitrary waveform (e.g., a sinusoidal waveform and a triangle waveform) other than the rectangle waveform as exemplified in the aforementioned embodiment. Further, in the aforementioned embodiment, the four power supply circuits VA, VB, VC, and VD are provided to generate the four-phase AC voltages with a phase difference of 90 degrees between any adjacent two of the power supply circuits VA, VB, VC, and VD in the aforementioned order. However, three power supply circuits may be provided to generate three-phase AC voltages with a phase difference of 120 degrees between any two of the three power supply circuits.

The configuration and the location of the electric-field transfer board 62 are not limited to those exemplified in the aforementioned embodiment. For example, a portion of the electric-field board 62 around the toner carrying position TCP may be formed in a flat plate shape or a downward-recessed shape along the brush layer 61a of the development roller 61.

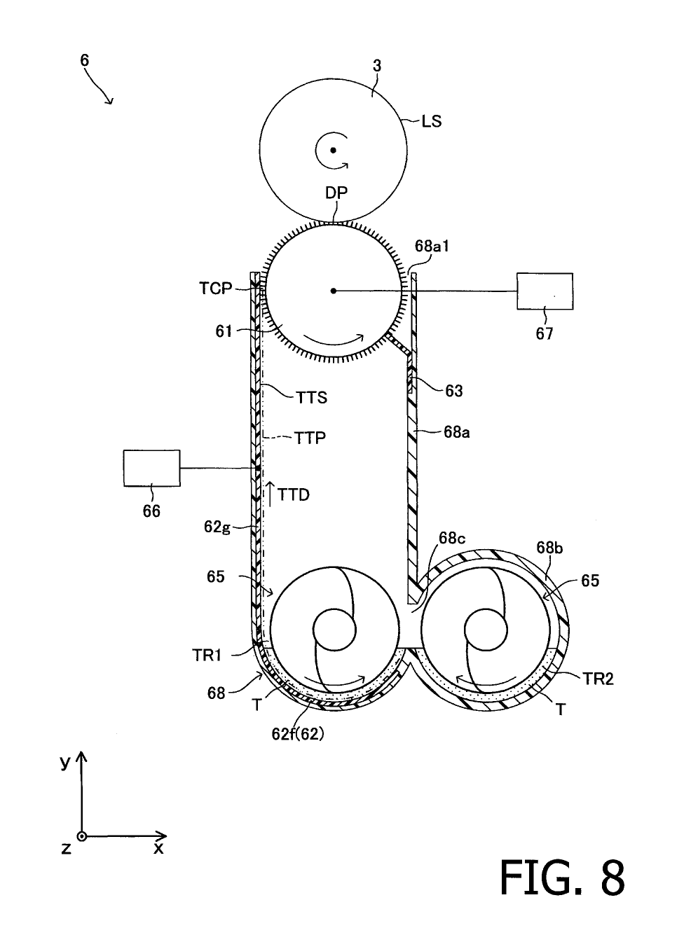

FIG. 8 is a cross-sectional side view schematically showing a configuration of a toner supply device 6 in a modification according to aspects of the present invention. As shown in FIG. 8, in the modification, the toner supply device 6 may include an electric-field transfer board 62 configured to supply toner T onto the development roller 61 in a direction against a moving direction of an outer circumferential surface of a development roller 61 in a toner carrying position TCP. In this respect, however, the electric-field transfer board 62 may be configured to supply the toner T onto the development roller 61 in the same direction as the moving direction of the outer circumferential surface of the development roller 61 in the toner carrying position TCP.

Specifically, in the modification, a casing 68, which forms a main body frame of the toner supply device 6, includes a main casing 68a that is a box-shaped member formed substantially in a “U” shape in a cross-sectional side view thereof and having a longitudinal direction along the vertical direction (the y-axis direction in FIG. 8). Namely, the toner supply device 6 is provided with an opening 68a1 open up toward the photoconductive drum 3, in a top position of the main casing 68a where the main casing 68a faces the photoconductive drum 3.

A sub casing 68b is disposed to be parallel to a bottom portion of the main casing 68a. The sub casing 68b is formed substantially in a cylindrical shape having a center axis line parallel to the main scanning direction. A toner storage room TR2 is provided in the sub casing 68b. A toner storage room TR1 provided in the bottom portion of the main casing 68a is configured to communicate with the toner storage room TR2, which is a space inside the sub casing 68b, via a communication hole 68c provided at each end of the toner storage room TR1 (the toner storage room TR2) in the main scanning direction.

Each bottom portion of the main casing 68a and the sub casing 68b contains an auger 65 therein. The augers 65 are configured to agitate and circulate the toner T in the toner storage rooms TR1 and TR2.

The development roller 61 is housed in the casing 68 in such a manner that a center axis of the development roller 61 is disposed inside the main casing 68a, and that most of an upper half portion of the development roller 61 is exposed to an outside of the main casing 68a. Further, development roller 61 is rotatably supported at an upper end of the main casing 68a where the opening 68a1 is formed.

Inside the main casing 68a, the electric-field transfer board 62 is provided along a toner transfer path TTP formed substantially in an oval shape having a longitudinal direction along the vertical direction in a cross-sectional side view. The electric-field transfer board 62 is tightly attached at a side, opposed to the communication holes 68c, of an inner wall surface of the main casing 68a.

The electric-field transfer board 62 is tightly attached to the inner wall surface of the main casing 68a over an area from a bottom surface of the toner storage room TR1 that is formed substantially in an upward-open half-cylindrical shape to a vertically extending surface. In the modification, the electric-field transfer board 62 is formed as a single seamless body having a mirror-reversed “J” shape in a cross-sectional side view. Namely, the electric-field transfer board 62 includes a curving plate section 62f formed substantially in a half-cylindrical shape to face the toner storage room TR1 and a vertically-extending flat plate section 62g.

An upper end of the electric-field transfer board 62 is located as high as the center axis of the development roller 61. The electric-field transfer board 62 is configured to transfer the toner T stored in the toner storage room TR1 up toward the toner carrying position TCP in the vertical direction.

A regulating member 63 is tightly attached to a side, of the inner wall surface of the main casing 68a, at which the communication holes 68c are provided (i.e., a side opposite to a side at which the electric-field transfer board 62 is provided).

According to the toner supply device 6 configured as above in the modification, it is possible to prevent the toner T from leaking to the outside of the toner supply device 6 in a favorable manner.

What is claimed is:

1. A developer supply device configured to supply charged development agent to an intended device, comprising:
an electric-field transfer board comprising a plurality of transfer electrodes arranged along a predetermined developer transfer path, the electric-field transfer board configured to transfer the development agent along the predetermined developer transfer path from a developer storage section that accommodates the development agent, when a multi-phase alternating-current voltage is applied to the plurality of transfer electrodes;
a brush roller disposed to face the intended device in a predetermined developer supplying position and face the electric-field transfer board in a predetermined developer carrying position, the brush roller configured to receive the development agent from the electric-field transfer board in the predetermined developer carrying position and supply the received development agent to the intended device in the predetermined developer supplying position; and
a regulating member configured to contact the brush roller in a position between the predetermined developer carrying position and the predetermined developer supplying position so as to regulate an amount of the development agent carried on the brush roller.

2. The developer supply device according to claim 1,
wherein the brush roller is disposed to contact the electric-field transfer board in the predetermined developer carrying position.

3. The developer supply device according to claim 1,
wherein the electric-field transfer board comprises a flat-plate-shaped section disposed between the developer storage section to the predetermined developer carrying position and configured to transfer the development agent upward in a vertical direction.

4. The developer supply device according to claim 2,
wherein the electric-field transfer board comprises a flat-plate-shaped section disposed between the developer storage section to the predetermined developer carrying position and configured to transfer the development agent upward in a vertical direction.

5. An image forming apparatus comprising:
an image carrying body configured to carry an electrostatic latent image formed thereon; and
a developer supply device configured to supply charged development agent to the image carrying body to develop the electrostatic latent image carried on the image carrying body, the developer supply device comprising:
a developer storage section configured to accommodate the development agent;
an electric-field transfer board comprising a plurality of transfer electrodes arranged along a predetermined developer transfer path;
a transfer bias supply circuit configured to supply a multi-phase alternating-current voltage to the plurality of transfer electrodes on the electric-field transfer board to transfer the development agent along the predetermined developer transfer path from the developer storage section toward a predetermined developer carrying position;
a brush roller disposed to face the image carrying body in a predetermined developer supplying position and face the electric-field transfer board in the predetermined developer carrying position, the brush roller configured to receive the development agent from the electric-field transfer board in the predetermined developer carrying position and supply the received development agent to the image carrying body in the predetermined developer supplying position; and
a regulating member configured to contact the brush roller in a position between the predetermined developer carrying position and the predetermined developer supplying position so as to regulate an amount of the development agent carried on the brush roller.

6. The developer supply device according to claim 5,
wherein the brush roller is disposed to contact the electric-field transfer board in the predetermined developer carrying position.

7. The developer supply device according to claim 5,
wherein the electric-field transfer board comprises a flat-plate-shaped section disposed between the developer storage section to the predetermined developer carrying position and configured to transfer the development agent upward in a vertical direction.

8. The developer supply device according to claim 6,
wherein the electric-field transfer board comprises a flat-plate-shaped section disposed between the developer storage section to the predetermined developer carrying position and configured to transfer the development agent upward in a vertical direction.
